(19) United States
(12) Patent Application Publication
(10) Pub. No.: US 2002/0187695 A1
(43) Pub. Date: Dec. 12, 2002

(54) Composition for manufacturing coated cloth-based substrates

(76) Inventor: William Frederick Burgess, Johnson City, TN (US)

Correspondence Address: VEDDER PRICE KAUFMAN & KAMMHOLZ, 222 N LASALLE STREET, CHICAGO, IL, 60601, US

(21) Appl. No.: 09/810,728

(22) Filed: Mar. 16, 2001

(51) Int. Cl. B32B 5/02; B32B 3/00; B32B 9/00

(52) U.S. Cl. 442/59

(57) ABSTRACT

A method of providing an improved textile material suitable for use as a book cover or as a substrate for fine art or photographic reproductions. The method includes providing a backing sheet of a textile material, backfilling such material with a composition which may include one or more various starches and/or dextrin, in some cases a polyvinyl alcohol and an emulsified wax or the like and a suitable amount of water, and thereafter coating the pre-treated textile backing sheet with a final coating comprising one or more cooked starches, a film forming material such as polyvinyl acetate/polyvinyl acetate ethylene emulsion, a clay filler, a pigment and sufficient water, and calendering the material into a compressed, impregnated cloth in final form wherein the coated material is reduced in thickness compared to the original material.

### BACKGROUND OF THE INVENTION

The present invention relates generally to coated cloth materials, and particularly, to the method of creating a treated cloth or textile material so that the same is adaptable to various uses that have not previously been considered.

More particularly, the invention relates to various coated cloths which, following what is generally described as a backfilling step, a coating step, and a calendering step, is then preferably wrapped on a roll. After unrolling the treated cloth or textile material, it will quite surprisingly pass through a roll feed or a sheet feed electrostatic dry color copier and retain its desired color characteristics after taking on color from the copier.

In particular, the copier-ready coated cloth will pass through a color copier without any problem and moreover, will thereafter be suitable for various applications, including, for example, short run book covers. In addition, the material is also particularly suited to act as a substrate for fine art reproductions, and serving as a substrate for photographic images. The use as a fine art reproduction is enhanced by its appearance, in a proper case, as a canvas or canvas-like material.

The size of the threads and the thread count of this coated fabric may cause it to take on any number of textures and weaves, including that of a heavy cloth coating or perhaps a soft back or hard back cover or the like when used for book covers.

The textile material itself may be either 100% cotton, or in a suitable case, a cotton/polyester blend varying in thicknesses and weaves.

The coating is applied only after backfilling the sheet with a particular range of coating materials, including, in some cases, a small amount of pigment, and after this has been applied and suitably dried, the coating component or finish coat may be applied, after each step of which the textile is stretched on a tenter, passed through an oven and dried, and then calendered, and optionally placed into roll form for storage. The coated cloth then will have the desirable characteristics referred to above, depending on the exact substrate.

Accordingly, it is an object of the invention to provide a coated cloth that will lay flat and pass through a color Xerox brand or other brand electrostatic color dry duplicator with the desired image printed thereon.

Another object of the invention is to create a treatment method that is useful for cloth or textile substrates of various kinds, including various thickness, thread count and size of the threads.

Yet another object of the invention is to provide a variety of formulas for coating a substrate comprising a woven cloth of cotton or blends of cotton and polyester which may be, for example, a print cloth, a duck or an oxford weave.

Still another object of the invention is to provide a coated material which possesses the characteristics of a starch and clay or like coated material, but which has a film forming emulsion therein which imparts crack resistance, improved adhesion to the substrate and water resistance, all of which are desirable characteristics, especially when used as the coating material for cloth book covers or for fine art reproduction substrates.

A further object of the invention is to provide a coating material which is smooth enough to impart a certain sheen, luster or glossiness to the finished product, although the substrate is made from a cotton or cotton-polyester material.

A still further object of the invention is to provide a method which includes placing all the ingredients in cold water, thoroughly dispersing them and thereafter, processing the backfilling coating and the finish coating through a jet cooker, whereafter they may be applied directly to the textile material to create the desired product.

An additional object of the invention is to provide a method which includes applying a backfilling material, tentering the backfilled substrate, and passing it through an oven until dry, and creating a roll of such material, and thereafter repeating the steps with the final coating material except that such material is also calendered before being taken up on a roll.

The invention achieves these objects and others which are inherent therein by providing a backing sheet of a textile material, backfilling such material with a composition which may include one or more various starches and/or dextrin, in some cases a polyvinyl alcohol and an emulsified wax or the like and a suitable amount of water, and thereafter coating the pretreated textile backing sheet with a final coating comprising one or more cooked starches, a film forming material such as polyvinyl acetate/polyvinyl acetate ethylene emulsion, a clay filler, a pigment and sufficient water, and calendering the material into a compressed, impregnated cloth in final form wherein the coated material is reduced in thickness compared to the original material.

The manner in which these and other objects of the invention are achieved in practice will become more clearly apparent when reference is made to the following detailed description of the preferred embodiments of the present invention set forth by way of example.

### DETAILED DESCRIPTION OF THE INVENTION

Although the invention may be carried out using different cloth weaves and different types of coatings, and made by either continuous or non-continuous methods, a number of examples are set forth below.

### EXAMPLE 1

It was desired to create a thoroughly coated material from a 100% cotton sheet. The geometric weave of the material used in this example has 62 threads in the warp or machine direction and 54 threads in the fill or cross direction. This pattern of weave provides certain satisfactory physical values of tensile and tear strength. A backfilling component for the textile is created as follows:

| BACKFILLING COMPONENT | AMOUNT (WT. %) |
|---|---|
| Water | 67.25 |
| Corn starch | 14.42 |
| Wheat starch | 6.92 |
| Dextrin | 2.88 |
| Polyvinyl alcohol | 5.77 |
| Polyethylene wax | 0.06 |
| Sodium salt of polymeric carboxylic acid | 0.06 |
| C.I. Pigment Blue 29 | 0.02 |
| Sodium carbonate | 0.02 |
| Petroleum wax, fatty emulsifiers | 1.27 |
| Sulfonated tallow | 0.35 |
| C.I. Pigment White 6 (titanium dioxide) | 0.69 |
| Polyethylene emulsion | 0.29 |

All of these ingredients are dispersed in cold water, and then the mixture is processed or cooked through a jet cooker of a type known to those skilled in the art of compounding textile coatings. In this device, the backfilling or coating mixture is exposed to pressurized steam at a temperature of about 240° F., which gelatinizes the starches and dextrins, thereby raising the viscosity of the mixture and facilitating the filling and coating of the substrate.

Once the backfilling compound has been deposited, the material is introduced into a tenter oven, with side clips or pins thereon maintaining the cloth under tension, and when thoroughly dried, the material is rolled onto a takeup roller.

This treatment completely fills all interstices of the fabric on both the face and the backside of the material, virtually encapsulating the cloth in the coating.

The next phase consists of preparing a coating component containing the following ingredients.

| COATING COMPONENT | AMOUNT (WT. %) |
|---|---|
| Water | 35.2 |
| Phosphate ester | .3 |
| C.I. Pigment White 6 (titanium dioxide) | 7.4 |
| Kaolin clay (mineral filler) | 7.4 |
| Corn starch | 9.9 |
| Potato starch | 2.5 |
| Wheat starch | 2.5 |
| Mineral oil defoamer | .07 |
| Polyvinyl acetate/polyvinyl acetate ethylene | 34.7 |
| emulsion | |

The components are again mixed in water and processed through the jet cooker and thereupon coated on to the backfilled substrate material, which is being unwound from the roller. The substrate material is again placed in a tenter with tension maintained by side clips and passed through an oven for drying. From here the material is calendered by multiple rollers and reduced to its final thickness, in this case being 6.5 mils. The finished material has an overall density of 5.1 oz. per sq. yd. (±0.2), and presents a glossy appearance such as could be obtained by a starch/clay coating, but the material has better adhesion, crack-resistance and exhibited sufficient water resistance to allow gentle cleaning with mild soap and water-dampened wipes.

### EXAMPLE 2

A second material was prepared which had a thickness of 11.5 mils and was also 100% cotton. The thread count of this material was 64 threads in the machine direction and 56 threads per inch in the cross direction. The material was treated with the same coating materials and by the same process, and was finally reduced by calendering from 11.5 mils to 8.4 mils. Here the textile material itself had a density of 4.6 oz. per sq. yd., and the finished material has a density of 5.9 oz. per sq. yd.

### EXAMPLE 3

A material having a caliper of 13.2 mils and comprised of a 65/35 mixture of polyester and cotton was prepared according to the same method set forth above. The material had a thread count of 76 threads per inch in the machine direction but only 30 threads per inch across the machine. This material was prepared and subjected to the same backfilling and coating used in the above examples. The final thickness of this material following its drying and calendering was 10.5 mils and it had a density of 7.2 oz. per sq. yd.

### EXAMPLE 4

In this case, the caliper of the cloth was 14.3 mils. The material had a thread count of 76 threads per inch in the machine direction and only 30 threads per inch across the machine. The material was again made from a 65/35% mixture of polyester and cotton. When the final coating was applied, it had an average density of 7.4 oz. per sq. yd. and a caliper of 10.6 mils following calendering.

### EXAMPLE 5

Next, a material having a caliper of 17.6 mils was used. The material had a thread count of 84 threads per inch in the machine direction, but only 28 threads per inch in the cross direction and was 100% cotton duck material, having a density of 7.0 oz. per sq. yd. This was again backfilled and finally coated with the same material. When it was finished, it had a thickness of 11.8 mils and a finished density of 8.5 oz. per sq. yd.

### EXAMPLE 6

A textile material having the same weave and thread count as set forth in Example 1 was selected, and the method was the same as in that example. However, the backfilling component was made as follows:

| BACKFILLING COMPONENT | AMOUNT (WT. %) |
|---|---|
| Water | 71.5 |
| Corn starch | 9.2 |
| Wheat starch | 6.9 |
| Dextrin | 9.2 |
| C.I. Pigment Blue 29 | .01 |
| Sodium carbonate | .01 |
| Petroleum wax, fatty emulsifiers | 1.1 |
| C.I. Pigment White 6 (titanium dioxide) | .5 |
| Polyethylene emulsion | .5 |
| Kaolin clay (mineral filler) | 1.1 |

In this example, no polyvinyl alcohol, no polyethylene wax and no polymeric carboxylic acid salts were used. Likewise, no sulfonated tallow was used. In this example, 1.1 parts by weight of a mineral filler, in this case kaolin clay was used. The coating component was the same as that in Example 1.

The results were the same as in Example 1, as far as caliper and density were concerned.

### EXAMPLE 7

The backfilling composition of Example 6 was used with the material of Example 2. Then the coating of Example 1 was applied. The results were the same, having the same thickness and density as that of Example 2.

### EXAMPLES 8-10

The backfilling composition of Example 6 was applied to the fabric of Examples 3-5. Then the coating composition of Examples 3-5 was applied. The resulting materials had the same thickness and density as their counterparts in Examples 3-5.

### EXAMPLE 11

A fabric or textile material of Example 1 was selected, and backfilled according to either Example 1 or Example 6. The specimen was then treated with a coating composition as follows:

| COMPONENT | AMOUNT (WT. %) |
|---|---|
| Water | 28.4 |
| Phosphate ester | 0.4 |
| C.I. Pigment White 6 (titanium dioxide) | 6.4 |
| Kaolin clay (mineral filler) | 7.7 |
| Corn starch | 3.5 |
| Potato starch | 6.4 |
| Wheat starch | 2.5 |
| Mineral oil defoamer | 0.04 |
| Polyvinyl acetate/polyvinyl acetate ethylene | 38.8 |
| emulsion | |

After application and calendering, the fabric had the same caliper and density as its counterpart in Examples 1 or 6.

### EXAMPLES 12-15

A fabric material such as that in Examples 2-5 was selected, and after being backfilled with either backfilling composition, was treated with the coating composition of Example 11. The final product had the same density and caliper as that of Examples 2-5.

### EXAMPLE 16

A cloth material such as that in Example 1 was treated with a backfilling composition set out in the following table:

| COATING COMPONENT | AMOUNT (WT. %) |
|---|---|
| Water | 28.4 |
| Phosphate ester | .5 |
| C.I. Pigment White 6 (titanium dioxide) | 7.0 |
| Mineral filler (talc) | 7.0 |
| Corn starch | 3.5 |
| Potato starch | 6.4 |
| Wheat starch | 3.5 |
| Mineral oil defoamer | .04 |
| Polyvinyl acetate polyvinyl acetate ethylene | 43.6 |
| emulsion | |

The backfilling was applied in the same manner as set out in the above examples. Next, a coating composition was applied as set out below. It will be noted that the backfilling and coating compositions are identical.

| COATING COMPONENT | AMOUNT (WT. %) |
|---|---|
| Water | 28.4 |
| Phosphate ester | .5 |
| C.I. Pigment White 6 (titanium dioxide) | 7.0 |
| Mineral filler (talc) | 7.0 |
| Corn starch | 3.5 |
| Potato starch | 6.4 |
| Wheat starch | 3.5 |
| Mineral oil defoamer | .04 |
| Polyvinyl acetate polyvinyl acetate ethylene | 43.6 |
| emulsion | |

The coating was applied in the same manner and the caliper and density of the final product was the same as in Example 1.

### EXAMPLES 17-20

Fabric materials corresponding to those set out in Examples 2-5 were used with similar results.

### EXAMPLE 21

A fabric was selected according to any one of the foregoing examples, with the exception of the pigment. In this case, a dark green dye was applied to the fabric and allowed to take a set. Thereafter, the backfilling material was applied, except that instead of the blue and white additives, a suitable green pigment was placed in the backfilling. Thereafter, the coating was applied, except that the coating contained a suitable amount of a green pigment. The result was a coating material having a color other than white, with its value depending on the amount of pigment.

When these various materials were used for xerographic reproduction, they all reacted favorably. The materials maintained their flatness and dimensional stability, and most importantly, their ability to pass through color xerographic machines and to provide crisp, clean, glossy images without cracking, while having excellent adhesion within the coating and being highly water resistant. These materials were then suitable for use as book covers. In the alternative, the materials were good as substrates for art and photographic reproductions of all kinds. With the canvas-like textile which was treated as aforesaid, the final material resembled canvas, giving a reproduced work of art the appearance of having been painted on canvas rather than paper.

The illustrated examples generally comprehend rolling the textile on and off supply and takeup rollers. However, the process theoretically could also be carried out by treating sheets of textile material instead. The textile material should ultimately be cut into sheets and slit into smaller sheets before it is used. However, from the manufacturing standpoint, it is most conveniently carried out by performing the steps as the textile is supplied or taken up on rolls, although, the assignee presently intends to sell the product in either sheet or roll form.

It will thus be seen that the present invention provides an improved textile book cover or substrate for artistic or photographic images with an improved coating having a number of advantages and characteristics including those expressly pointed out herein, and others which are inherent in the invention. An illustrative embodiment of the product of the invention having been shown and described, it is anticipated that variations to the described form of apparatus will occur to those skilled in the art and that such modifications and changes may be made without departing from the spirit of the invention, or the scope of the appended claims.

I claim:

1. A method of creating a treated textile material capable of being made into a cloth book cover, said method comprising, in combination, providing a backing sheet of a textile material having at least about 20 threads in the warp direction and at least about 20 threads in the fill direction, using a backfilling composition comprising about 10%-30% of a starch component, about 0% to about 15% dextrin, about 0%-50% of an emulsion containing polyethylene or polyvinyl acetate/polyvinyl acetate ethylene, up to 10% of pigment and about 60% to about 88% water, heating said entire backfilling composition to at least 180° F. and applying said backfilling composition to said textile, then passing the textile through a drying oven and thereafter, selecting a coating composition comprising about 8% to 20% of a cooked starch, about 28% to about 50% of a polyvinyl acetate/polyvinyl acetate ethylene water emulsion, about 1% to about 10% of a clay filler, about 2% to about 12% of a pigment material and about 22% to about 32% of additional water, heating said entire coating composition to at least 180° F. and applying it to said backfilled textile, stretching said backfilled textile, passing said textile through a drying oven and calendering said backfilled and coated textile material through multiple rollers until said final coating composition is very smooth, and suitable for direct application of an electrostatic dry image on a sheet of said backfilled and coated textile material.

2. 2. A method as defined in claim 1, wherein said textile material has at least 60 threads per inch in the machine direction.

3. A method as defined in claim 1, wherein the textile material has about 30 or more threads per inch across the machine.

4. A method as defined in claim 1, wherein said backfilling component includes, as a part of the starch component, about 2% to about 5% of dextrin.

5. A method as defined in claim 1, wherein said backfilling component comprises from about 5% to about 8% of potato starch.

6. A method as defined in claim 1, wherein said backfilling component includes about 0% to 50% of an emulsion containing polyvinyl acetate/polyvinyl acetate ethylene and said emulsion comprising about 40% to about 50% of polyvinyl acetate/polyvinyl acetate ethylene emulsion.

7. A method as defined in claim 1, wherein said backfilling step includes heating said entire composition in a jet cooker fed with pressurized steam at at least 220° F.

8. A method as defined in claim 1, wherein said step of coating said backfilled composition comprises heating said composition in a jet cooker fed with pressurized steam at at least 220° F.

9. A method as defined in claim 1, wherein said starch component of said backfilling composition comprises about 12% to about 17% starch.

10. A method as defined in claim 1, wherein said polyvinyl acetate/polyvinyl acetate ethylene emulsion of said backfilling composition comprises from about 35% to about 46% of said polyvinyl acetate/polyvinyl acetate ethylene emulsion.

11. A method as defined in claim 1, which further includes about 6% to about 8% pigment in said backfilling composition.

12. A method as defined in claim 1, wherein said coating composition includes from about 5% to about 8% of titanium dioxide pigment.

13. A method as defined in claim 1, in which said backfilling component includes up to 8% of a mineral filler material.

14. A method as defined in claim 1, wherein said coating composition includes about 5% to 8% of a mineral filler material.

15. A method as defined in claim 1, wherein said textile material comprises substantially pure cotton.

16. A method as defined in claim 1, wherein said textile material comprises a cotton/polyester blend.

17. A method as defined in claim 1, which includes the steps of supplying the textile from a roller, taking said textile up on a roller following backfilling, supplying said textile for the final coating step from a supply roller and taking said textile up again on another takeup roller following said coating step.

18. A cloth book cover, said book cover being made from a backing sheet of a textile material having at least 20 threads in the warp direction and at least 20 threads in the fill direction, and wherein said sheet has been completely backfilled with a backfilling material comprising about 3%-18% of a corn starch material, about 5%-10% of a wheat starch material, up to about 8% of a potato starch material, up to about 5% of a dextrin material, up to about 9% polyvinyl alcohol, about 0% to about 3% of an emulsifier for wax and wax-like materials, a minor amount of pigment and up to 50% of a polyvinyl acetate/polyvinyl acetate ethylene emulsion, and about 25% to about 75% water, exclusive of water contained in the polyvinyl acetate/polyvinyl acetate ethylene emulsion, said components having been placed in said water and heated to at least 180° F. and until said starch component is fully swelled, said textile material then being oven-dried, said textile material being coated thereafter with a final coating comprising about 9% to 19% of a starch material, about 32% to about 50% of a polyvinyl acetate/polyvinyl acetate ethylene water emulsion, about 2% to about 10% of a mineral filler material, up to about 12% of a pigment material and about 22% to about 40% water, exclusive of the water in said emulsion, said cover being thereafter oven-dried and calendered until very smooth and thereafter being suitable for receiving an image placed thereon by passing said treated cloth book cover material through an electrostatic dry copier.

19. A method as defined in claim 18, which includes the steps of supplying the textile from a roller, taking said textile up on a roller following backfilling, supplying said textile for the final coating step from a supply roller and taking said textile up again on another takeup roller following said coating step.

20. A method of creating a web of treated textile material suitable for being cut into sheets and made into cloth book covers, said method comprising, in combination, providing a web of a textile material having at least about 20 threads in the warp direction and at least about 20 threads in the fill direction, selecting a backfilling composition comprising about 10%-30% of a starch component, about 0% to about 15% dextrin, about 0%-50% of an emulsion containing polyethylene or polyvinyl acetate/polyvinyl acetate ethylene, up to 10% of pigment and about 20% to about 88% water, heating said entire composition to at least 180° F., unrolling said web of textile material and applying said backfilling composition to said web of textile material, passing said web of textile material through a drying oven and taking up said web on a second roller, and thereafter, unrolling said backfilled textile web material from said second roller and using a coating composition comprising about 8% to 20% of a cooked starch, about 28% to about 50% of a polyvinyl acetate/polyvinyl acetate ethylene water emulsion, about 1% to about 10% of a clay filler, about 2% to about 12% of a pigment material and about 22% to about 32% of additional water, heating said entire coating composition to at least 180° F., applying said coating to said web of textile material and thereafter stretching said textile material, drying said textile material in an oven, calendering said backfilled and coated textile material through multiple rollers until said final coating composition is very smooth, and taking up said coated web of textile material on another roller, whereby a web of material suitable for being cut into sheet form and having an electrostatic dry image applied to said backfilled and coated textile material.
